(19) United States
(12) Patent Application Publication
(10) Pub. No.: US 2015/0362977 A1
(43) Pub. Date: Dec. 17, 2015

(54) ELECTRONIC DEVICE, METHOD, AND COMPUTER PROGRAM PRODUCT

(71) Applicant: Kabushiki Kaisha Toshiba, Tokyo (JP)

(72) Inventor: Kenichi Doniwa, Asaka Saitama (JP)

(21) Appl. No.: 14/509,507

(22) Filed: Oct. 8, 2014

Related U.S. Application Data
(60) Provisional application No. 62/013,213, filed on Jun. 17, 2014.

(51) Int. Cl. G06F 1/32; G06F 21/32; G06F 1/16

(52) U.S. Cl. CPC G06F 1/3231; G06F 1/163; G06F 21/32

(57) ABSTRACT

According to an embodiment, an electronic device is wearable by a user. The electronic device includes a first sensor, a second sensor, processing circuitry, and a power supply circuitry. The first sensor includes to measure a first physiological information of the user. The first physiological information is used to determine a wearing state of the electronic device. The second sensor includes to measure a second physiological information of the user. The processing circuitry includes to perform authentication of a user by using the second physiological information. The power supply circuitry includes to start, when a wearing state of the electronic device changes from an unworn state to a worn state, supplying power to the second sensor, and to stop, when the authentication of the user is completed, at least a portion of supplying power to the second sensor.

This application claims the benefit of U.S. Provisional Patent Application No. 62/013,213, filed Jun. 17, 2014.

### FIELD

Embodiments described herein relate generally to an electronic device, a method, and a computer program product.

### BACKGROUND

Conventionally, there has been proposed an electronic device such as a wearable device that is worn and used by a user. Such an electronic device can acquire the amount of activity and physiological information of the user, as well as can collaborate with a smartphone, etc.

Such an electronic device often deals with information related to user privacy by its very nature. Therefore, from perspective of information security, it is desirable to limit a third person to use the electronic device. In this regard, it is considered to enhance the security of the electronic device by installing therein a biometric sensor such as a fingerprint authentication sensor. However, such a fingerprint sensor consumes large electrical power while the battery capacity of the electronic device such as the wearable device is limited. Therefore, an operation time of the electronic device in which the fingerprint sensor is installed might be shortened.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of an external appearance of a wearable device according to a first embodiment;

FIG. 2 is an exemplary block diagram of a hardware configuration of the wearable device of the first embodiment;

FIG. 3 is an exemplary block diagram of a biometric security module of the first embodiment;

FIG. 4 is an exemplary flowchart of a biometric security process of the first embodiment;

FIG. 5 is an exemplary table for explaining a wearing state of the wearable device and change in wearing state over time of the first embodiment;

FIG. 6 is an exemplary table for explaining a process performed in accordance with the change in wearing state over time, of the first embodiment;

FIG. 7 is an exemplary flowchart of a fingerprint authentication process illustrated in FIG. 6 of the first embodiment;

FIG. 8 is an exemplary block diagram of a hardware configuration of a wearable device according to a second embodiment;

FIG. 9 is an exemplary block diagram of a biometric security module of the second embodiment;

FIG. 10 is an exemplary flowchart of a biometric security process of the second embodiment;

FIG. 11 is an exemplary table for explaining action of a user and a change in action over time, of the second embodiment;

FIG. 12 is an exemplary table for explaining a process performed in accordance with the change in wearing state overtime and the change in action over time, of the second embodiment;

FIG. 13 is an exemplary block diagram of a biometric security module according to a third embodiment;

FIG. 14 is an exemplary table for explaining a change in wearing state over time of the wearable device according to the third embodiment;

FIG. 15 is an exemplary table for explaining a process performed in accordance with the change in wearing state of the wearable device over time and the change in action of the user over time, of the third embodiment;

FIG. 16 is an exemplary flowchart of a re-authentication process illustrated in FIG. 15 of the third embodiment;

FIG. 17 is an exemplary block diagram of a biometric security module according to a fourth embodiment;

FIG. 18 is an exemplary table for explaining a process performed in accordance with a change in wearing state of the wearable device over time and a change in action of a user over time, according to the fourth embodiment;

FIG. 19 is an exemplary flowchart of an authentication rejection and function restriction process of the fourth embodiment;

FIG. 20 is an exemplary block diagram of a biometric security module according to a fifth embodiment; and

FIG. 21 is an exemplary flowchart of a process at the time of data transfer, of the fifth embodiment.

### DETAILED DESCRIPTION

In general, according to one embodiment, an electronic device is wearable by a user. The electronic device comprises a first sensor, a second sensor, processing circuitry, and a power supply circuitry. The first sensor comprises to measure a first physiological information of the user. The first physiological information is used to determine a wearing state of the electronic device. The second sensor comprises to measure second physiological information of the user. The processing circuitry comprises to perform authentication of the user by using the second physiological information. The power supply circuitry comprises to start, when a wearing state of the electronic device changes from an unworn state to a worn state, supplying power to the second sensor, and to stop, when the authentication of the user is completed, at least a portion of supplying power to the second sensor.

### First Embodiment

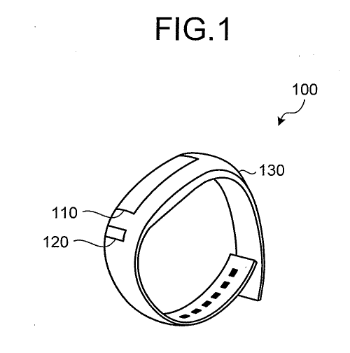

A first embodiment is described based on FIGS. 1 to 7. FIG. 1 is a diagram illustrating an exterior appearance of a wearable device 100 of the first embodiment. The wearable device 100 comprises a touch panel display 104, a fingerprint sensor 105, and a belt 130.

The wearable device 100 is a watch type wearable device, and is wearable around a wrist of a user via the belt 130. When used, the wearable device 100 can acquire physiological information, activity histories, etc., of the user, and the user can check the physiological information and the activity histories by operating the wearable device 100 via the touch panel display 104. Further, the wearable device 100 can collaborate with a device such as a smartphone connected thereto in wireless or wired manner, and the user can indirectly operate the device such as the smartphone via the wearable device 100. Here, the physiological information is information about the body of the user such as, for example, pulse wave, electrocardiogram, body temperature, and body motion. Further, the activity histories are information about activity of the user such as, for example, pedometer, moved distance, break and activity time, calorie consumption, and sleep.

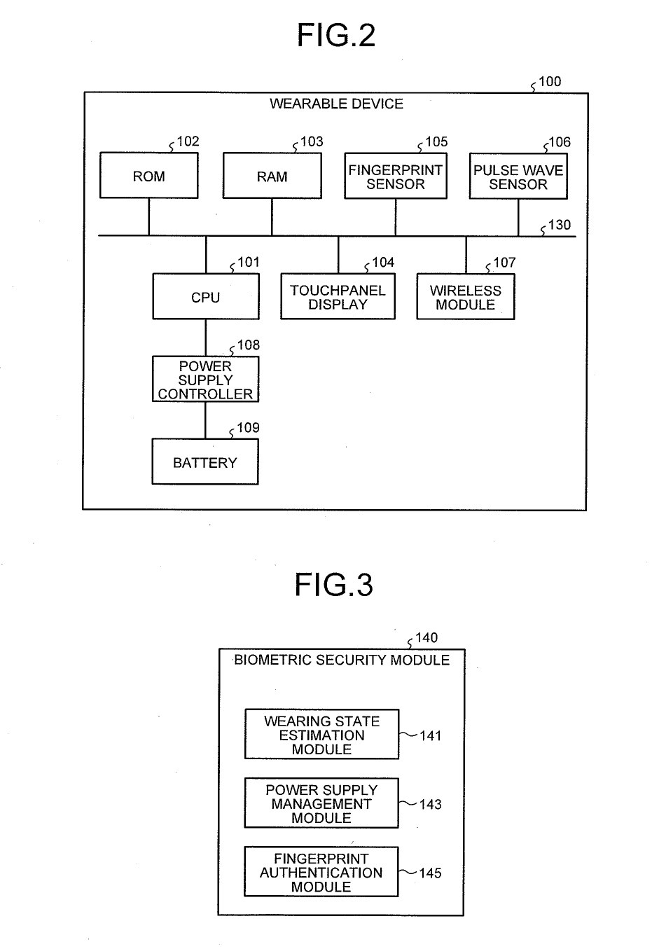

FIG. 2 is a block diagram illustrating a hardware configuration of the wearable device 100 of the present embodiment. The wearable device 100 comprises a central processing unit (CPU) (processing circuitry) 101, a read only memory (ROM) 102, a random access memory (RAM) 103, a touch panel display 104, a fingerprint sensor 105, a pulse wave sensor 106, a wireless module 107, a power supply controller (power supply circuitry) 108, and a battery 109. Here, the CPU 101, the ROM 102, the RAM 103, the touch panel display 104, the fingerprint sensor 105, the pulse wave sensor 106, and the wireless module 107 are connected to each other via a bus 130.

The CPU 101 controls operations of each components of the wearable device 100. In particular, the CPU 101 sequentially reads out and executes a firmware and various applications stored in the ROM 102, so as to control the operations of the each components of the wearable device 100. The ROM 102 stores therein a firmware, various applications, and various data required for implementing the firmware and the applications. The RAM 103 provides a work space for the CPU 101 to implement the firmware and the applications, as a main memory of the wearable device 100.

According to the control of the CPU 101, the touch panel display 104 displays images and the like, and acquires a touch operation of the user as input information. Here, the touch panel display 104 comprises: a display not illustrated for displaying the images and the like; and a touch panel not illustrated for detecting a touch position of the touch operation of the user with respect to the display. The display is, for example, a liquid crystal display (LCD) and/or an electro luminescence (EL) display. Further, the touch panel is of any type such as, for example, a capacitive touch panel or a resistive touch panel.

According to the control of the CPU 101, the fingerprint sensor 105 reads a surface of a finger of the user. The surface of the finger of the user read by the fingerprint sensor 105 is recorded in, for example, the ROM 102, as fingerprint data. Here, as long as the fingerprint sensor can read the surface of the finger of the user, it can be of any type, such as the area type or the sweep type as well as optical, capacitive, electrical field type, thermal, or pressure sensitive type.

According to the control of the CPU 101, the pulse wave sensor 106 measures pulse waves at every predetermined time (i.e., every 30 seconds). The measured pulse waves are recorded in, for example, the ROM 102 as the pulse wave data, together with the measured time. As the pulse wave sensor 106, any sensor can be used such as a sensor that uses an optical sensing technology, as long as the sensor can detect the pulse wave of the user.

According to the control of the CPU 101, the wireless module 107 performs wireless communication with other devices using wireless communication standard such as the Bluetooth (registered trademark). In particular, in case when the wearable device 100 is used in collaboration with a smartphone, the wireless module 107 establishes communication with the smartphone, and transmits the physiological information or the activity histories acquired by the wearable device 100 to the smartphone. Further, the wireless module 107 transmits the operation information of the user input via the touch panel display 104 to the smartphone, and thereafter, receives data transmitted from the smartphone in response to the operation information.

According to the control of the CPU 101, the power supply controller 108 performs control to supply power of the later described battery 109 to each component of the wearable device 100.

According to the control of the power supply controller 108, the battery 109 supplies power to each component of the wearable device 100. Here, the battery 109 is, for example, a lithium ion battery, and can be charged in wireless or wired manner.

In general, a wearable device by its nature handles information related to user privacy. Therefore, in terms of information security, it is not preferred that a third person can use the wearable device with no restrictions. Accordingly, it can be considered to mount to the wearable device a biometric sensor such as a fingerprint sensor so as to enable the user authentication. However, the wearable device by its very nature has limited battery capacity. Therefore, if the biometric sensor such as the fingerprint sensor that consumes comparatively large electrical power is installed in the wearable device, an operation time of the wearable device might be shortened.

Thus, according to the present embodiment, the fingerprint sensor 105 is installed in the wearable device 100 in order to enhance the security. Further, according to the present embodiment, pulse wave sensor 106 is used to estimate whether the wearable device 100 is being worn by the user, and the fingerprint sensor 105 is powered on and off in accordance with types of change in the wearing state of the wearable device 100 over time. As a result, security of the wearable device can be enhanced as well as the operation time is elongated since the power consumption of the wearable device is suppressed by turning on and off the fingerprint sensor in timely manner.

The ROM 102 stores therein a biometric security module 140 as a program. The CPU 101 sequentially executes each module (wearing state estimation module 141, power supply management module 143, fingerprint authentication module 145) of the biometric security module 140 stored in the ROM 102 to realize functions of the biometric security module 140. FIG. 3 is a block diagram of a functional configuration of the biometric security module 140 of the present embodiment. As illustrated in FIG. 3, the biometric security module 140 comprises the wearing state estimation module 141, the power supply management module 143, and the fingerprint authentication module 145.

The wearing state estimation module 141 estimates the wearing state of the wearable device 100 based on the pulse wave measured by the pulse wave sensor 106. Further, the wearing state estimation module 141 estimates a change in the wearing state over time based on the pulse waves measured at different measurement times. Here, the “wearing state” indicates whether the wearable device 100 is currently being worn by the user. The “wearing state” is indicated as “worn” when the wearable device 100 is currently being worn by the user, and indicated as “unworn” when the wearable device 100 is not currently being worn by the user. Further, the “change in wearing state over time” indicates whether the wearing state is changed over the time axis, such as when the wearing state is changed from “worn” to “unworn”. Different modes of the “wearing state” and different modes of the “change in wearing state over time” are distinguished from each other by, for example, raising a flag.

The power supply management module 143 manages power supply from the battery 109 to the fingerprint sensor 105 via the power supply controller 108, in accordance with control of the later described fingerprint authentication module 145. That is to say, the power supply management module 143 manages turning on and off the power of the fingerprint sensor 105. Here, the power of the fingerprint sensor 105 is normally off by the power supply management module 143, and the power is turned on by the power supply management module 143 only when an instruction from the fingerprint authentication module 145 is received.

The fingerprint authentication module 145 executes a process in accordance with modes of change in the wearing state over time, described later, when the wearing state estimation module 141 estimates that the wearing state of the wearable device 100 is changed over time.

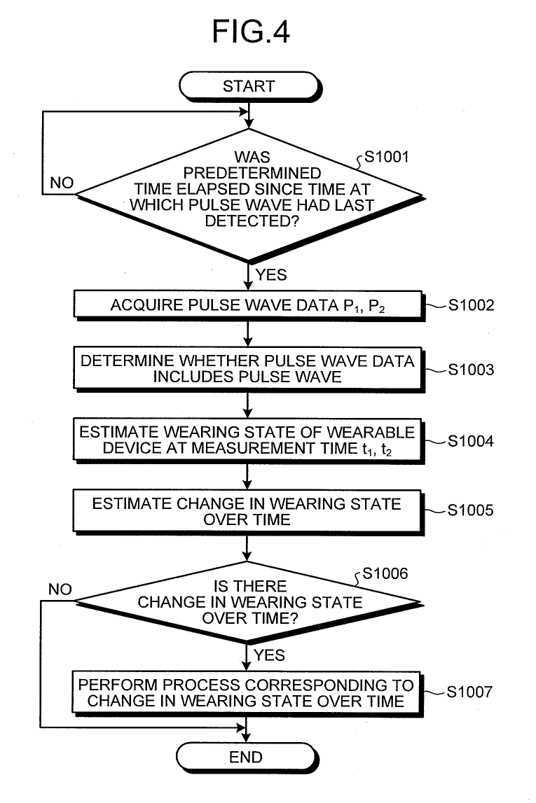

Next, a biometric security process by the biometric security module 140 is explained. FIG. 4 is a flowchart of the biometric security process.

First, the wearing state estimation module 141 determines whether a predetermined time (i.e., 10 to 20 seconds) has been elapsed since the time when the pulse wave is last measured (S1001). Then, when it is determined that the predetermined time has not been elapsed (No at S1001), the wearing state estimation module 141 repeats the process from S1001. On the other hand, when it is determined that the predetermined time has been elapsed (Yes at S1001), the wearing state estimation module 141 acquires the pulse wave last measured as pulse wave data P₁ at measurement time t₁, and acquires the pulse wave measured at current time as pulse wave data P₂ at measurement time t₂ (S1002).

Next, the wearing state estimation module 141 determines whether pulse waves are included in the pulse wave data P₁ and pulse wave data P₂ (S1003).

Next, the wearing state estimation module 141 estimates the wearing state of the wearable device 100 at each the measurement time t₁, t₂ based on the determination of the presence and absence of the pulse waves (S1004). Then, the wearing state estimation module 141 estimates the change in the wearing state over time based on the wearing states at the measurement time t₁, t₂ (S1005).

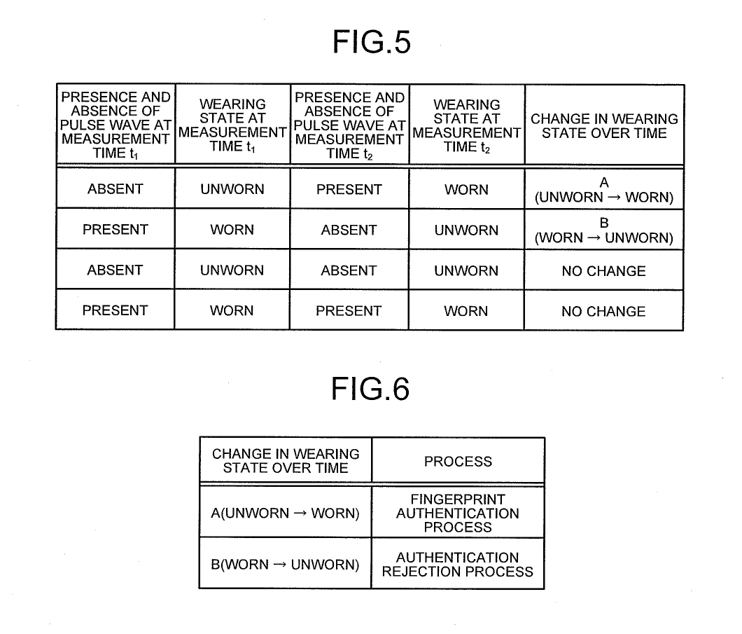

FIG. 5 is a table for explaining the wearing states of the wearable device 100 and the change in the wearing states over time. As illustrated in FIG. 5, when for example it is determined that the pulse waves are included in the pulse wave data P₁ at the measurement time t₁, the wearing state estimation module 141 estimates that the wearable device 100 is being worn (worn) by the user at the measurement time t₁. On the other hand, when it is determined that the pulse waves are not included in the pulse wave data P₂ at the measurement time t₂, the wearing state estimation module 141 estimates that the wearable device 100 is not being worn (unworn) by the user at the measurement time t₂. Then, the wearing state estimation module 141 compares the wearing state at the measurement time t₁ and the wearing state at the measurement time t₂, and estimates that the change in the wearing state over time is A(unworn→worn) if the wearing state is changed from “unworn” to “worn” over time. Further, the wearing state estimation module 141 estimates that the change in the wearing state over time is B (worn→unworn) if the wearing state is changed from “worn” to “unworn”. On the other hand, if there is no change in the wearing state over time, the wearing state estimation module 141 estimates that there is no change in the wearing state over time.

Referring back to FIG. 4, the fingerprint authentication module 145 determines whether the change in the wearing state over time estimated by the wearing state estimation module 141 indicates that such change is present (S1006). Then, when it is determined that there is no change in the wearing state over time (No at S1006), the process ends. On the other hand, if it is determined that there is change in the wearing state over time (Yes at S1006), the fingerprint authentication module 145 performs a process in accordance with different modes of change in the wearing state over time (S1007), and ends the process.

FIG. 6 is a table for explaining the process performed in accordance with different modes of changes in the wearing state of the wearable device 100 over As illustrated in FIG. 6, when the wearing state estimation module 141 estimates that the change in the wearing state of the wearable device 100 over time is A(unworn→worn), the fingerprint authentication module 145 performs a fingerprint authentication process described later. On the other hand, when the wearing state estimation module 141 estimates that the change in the wearing state of the wearable device over time is B (worn→unworn), the fingerprint authentication module 145 performs an authentication rejection process described later.

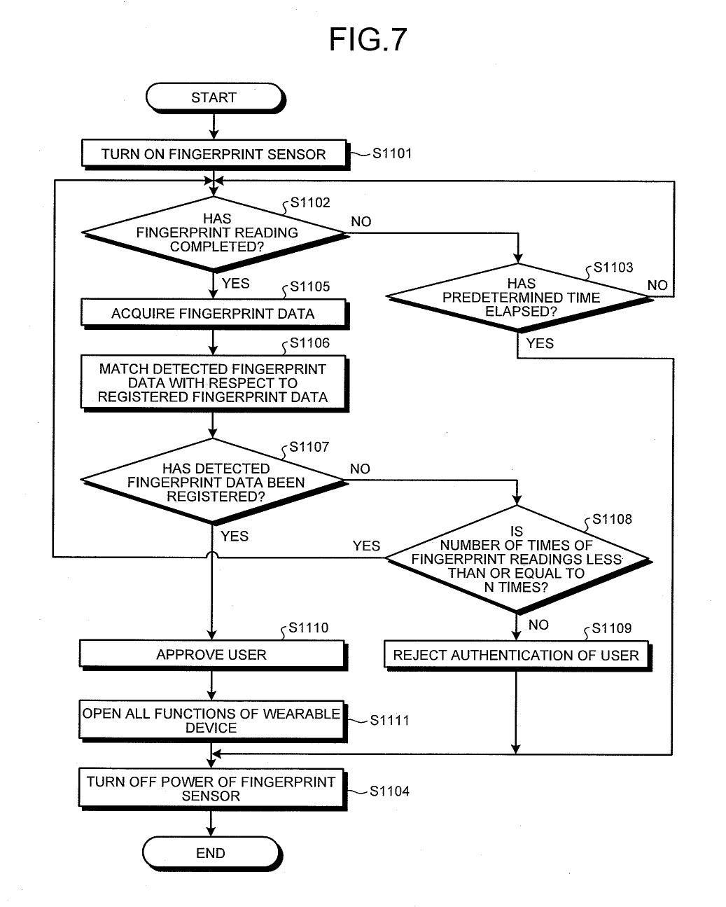

FIG. 7 is a flowchart of the fingerprint authentication process illustrated in FIG. 6. As illustrated in FIG. 7, if the change in the wearing state over time is A(unworn→worn), the fingerprint authentication module 145 instructs the power supply management module 143 to turn on the power of the fingerprint sensor 106. In response, the power supply management module 143 performs control to start supplying power to the fingerprint sensor 105 from the battery 109 via the power supply controller 108 (S1101).

Next, the fingerprint authentication module 145 determines whether reading of the fingerprint by the fingerprint sensor 105 is completed (S1102). As a result, if it is determined that the reading of the fingerprint is not completed (No at S1102), the fingerprint authentication module 145 determines whether a predetermined time (e.g., a few seconds) has been elapsed since the power of the fingerprint sensor 105 is turned on (S1103). Then, if it is determined that the predetermined time has not been elapsed (No at S1103), the fingerprint authentication module 145 repeats the process from S1102. On the other hand, if it is determined that the predetermined time has been elapsed while the reading of the fingerprint has not been completed (Yes at S1103), the fingerprint authentication module 145 turns off the power of the fingerprint sensor 105 via the power supply management module 143 (S1104), and ends the process.

On the other hand, if it is determined that the fingerprint reading is completed (Yes at S1102), the fingerprint authentication module 145 acquires the read fingerprint as fingerprint data (S1105). Next, the fingerprint authentication module 145 matches the acquired fingerprint data (in the following, referred to as acquired fingerprint) with the registered fingerprint data (hereinafter, referred to as the registered fingerprint data) (S1106).

Here, the registered fingerprint data is the fingerprint data of the user who is approved to use the wearable device 100. The registered fingerprint data is preliminarily registered in the wearable device by a user who performs the initial setting of the wearable device soon after the purchase thereof. The registered fingerprint data registered at the time of initial setting is stored in, for example, ROM 102.

As a fingerprint matching algorithms used for the matching between the acquired fingerprint data and the registered fingerprint data, any algorithm capable of the fingerprint matching can be used. For example, the pattern matching, the minutia matching, or the frequency analysis matching can be used as the fingerprint matching algorithm.

Next, the fingerprint authentication module 145 determines whether the acquired fingerprint data matches with the registered fingerprint data, i.e., whether the acquired fingerprint data has already been registered in the wearable device 100 (S1107). As a result, if it is determined that the acquired fingerprint data is not registered in the wearable device 100 (No at S1107), the fingerprint authentication module 145 checks a number of times of retry of the fingerprint authentication (S1108). Then, if the number of times of retries is less than or equal to N times (e.g., five times) (Yes at S1108), the fingerprint authentication module 145 repeats the fingerprint reading from S1102. Here, the fingerprint readings are sometimes incomplete depending on the condition of the fingerprint readings. Accordingly, a registered fingerprint is sometimes not determined as registered. Thus, the number of times of retires of the fingerprint authentication is confirmed by the process at S1108, and if the number of times of retries is less than or equal to N times, the fingerprint reading is performed again.

If it is determined that the number of times of retries is greater than N times, or in other word, if it is determined that the fingerprint is not registered even when the fingerprint authentication is repeated for N times (No at S1108), the fingerprint authentication module 145 rejects the authentication of the user who is wearing the wearable device 100 (S1109). Then, the fingerprint authentication module 145 instructs the power supply management module 143 to turn of the power of the fingerprint sensor 106. Accordingly, the power supply management module 143 performs control to stop supplying power from the battery 106 to the fingerprint sensor 106 via the power supply controller 108 (S1104), and ends the process.

On the other hand, if it is determined that the acquired fingerprint data has been registered in the wearable device 100 (Yes at S1107), the fingerprint authentication module 145 approves the user who is wearing the wearable device 100 (S1110). Then, the fingerprint authentication module 145 enables the user to use all of the functions of the wearable device 100 (S1111), and thereafter, instructs the power supply management module 143 to turn off the power of the fingerprint sensor 105. Accordingly, the power supply management module 143 performs controlling to stop supplying power from the battery 109 to the fingerprint sensor 105 via the power supply controller 108 (S1104). Then, the process ends. Here, the enabling the user to use all of the function of the wearable device 100 means that the approved user can access all of the functions of the wearable device, such as to view the physiological information or activity histories or to operate the smartphone.

If the fingerprint authentication process is finished as described above and the user is approved, the approved state is maintained until the user is rejected by the authentication rejection process described later. Consequently, until the user is rejected, the user becomes capable of using all of the function of the wearable device 100. Therefore, the user can view the physiological information and/or the activity histories as well as indirectly operates a device such as the smartphone.

Next, the authentication rejection process illustrated in FIG. 6 is explained. If the wearing state estimation module 141 estimates that the change in the wearing state of the wearable device over time is B (worn→unworn), the fingerprint authentication module 145 performs the authentication rejection process. The authentication rejection process is a process for rejecting the user. If the user has been approved by the fingerprint authentication process illustrated in FIG. 7, for example, the authentication rejection process rejects the approved user. That is to say, according to the authentication rejection process, even if the user is already approved, the user is rejected and he or she is again required to perform authentication if the wearable device is to be continuously used. Consequently, even if for example the user accidently drops the wearable device 100 and the wearing state of the wearable device 100 is changed from worn to unworn, the user is automatically rejected. Therefore, a third person who later picks up the wearable device 100 must perform the fingerprint authentication process.

As described above, the wearable device 100 of the present embodiment includes the fingerprint sensor 105. Further, the wearable device 100 of the present embodiment performs controlling to turn on and off the power of the fingerprint sensor 105 in accordance with different modes of the changes in the wearing state of the wearable device 100 over time, and performs the fingerprint authentication process. Consequently, the security can be enhanced as well as the power consumption of the wearable device 100 can be reduced since the power of the fingerprint sensor can be turned on only when required.

### Second Embodiment

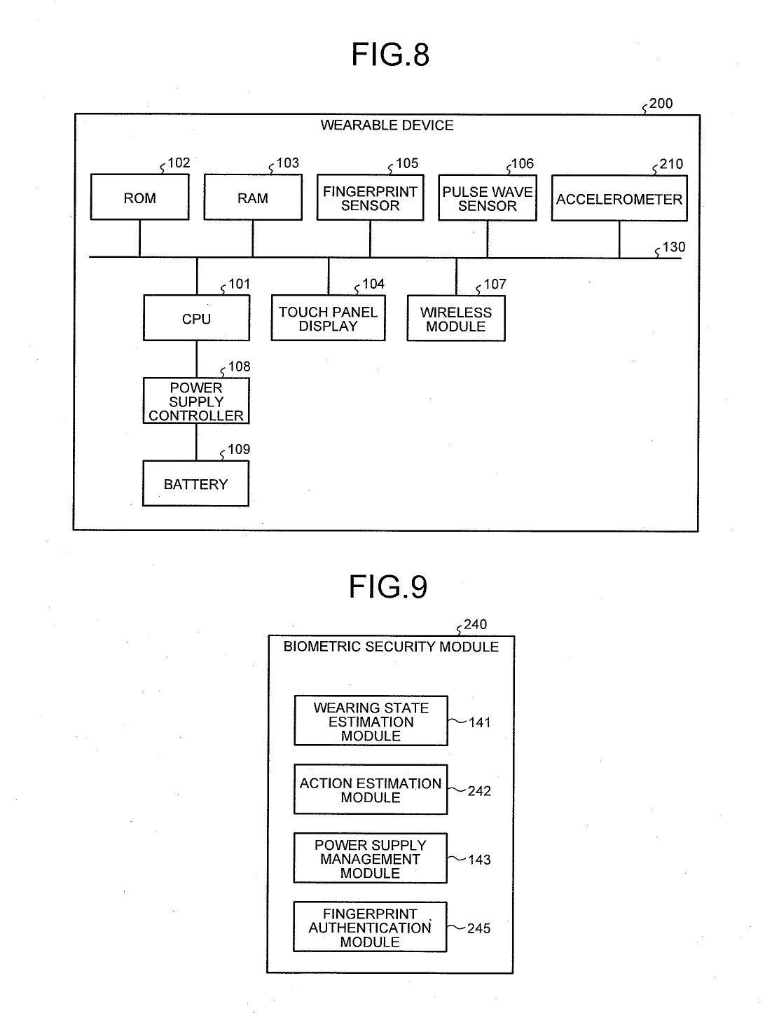

Next, a second embodiment is described based on FIGS. 8 to 12. FIG. 8 is a block diagram illustrating a hardware configuration of a wearable device 200 of the second embodiment. The wearable device 200 of the present embodiment comprises an accelerometer 210 in addition to configurations similar to that of the hardware configuration of the wearable device of the first embodiment. The same components as that of the first embodiment are referred to by numerals the same as that of the first embodiment, and the explanations thereof are omitted.

According to the control of the CPU 101, the accelerometer 210 measures accelerations in three axes directions (x-axis direction, y-axis direction, z-axis direction) at every predetermined time (e.g., 30 ms). The measured acceleration is stored in the ROM 102, for example, together with the measurement time, as acceleration data. The accelerometer 210 is connected to other configurations of the wearable device 200 via the bus 130, as similar to other configurations. Here, the accelerometer 210 of the present embodiment is not limited to a sensor that detects the acceleration in the three axes directions. Thus, any sensor such as a sensor that detects acceleration in one axis direction or two axes directions and/or a sensor that detects angular velocity around the axis in addition to the acceleration in the axial direction.

The wearable device 100 of the first embodiment performs the fingerprint authentication process even in the case when the user starts walking while not wearing the wearable device 100 and thereafter wears the wearable device 100 while walking. However, if the fingerprint authentication process is performed while walking, the fingertip of the user cannot be stay still with respect to the fingerprint sensor, and the reading of the fingerprint might not be performed sufficiently. Therefore, according to the present embodiment, action of the user is estimated by using the accelerometer 210, and turning on and off the power of the fingerprint sensor is determined based on the change in the wearing state over time as well as the change in action over time.

A biometric security module 240 is stored in the ROM 102 as a program. The CPU 101 executes each component (wearing state estimation module 141, action estimation module 242, power supply management module 143, fingerprint authentication module 245) of the biometric security module 240 to realize functions of the biometric security module 240. FIG. 9 is a block diagram illustrating functional configurations of the biometric security module 240 of the second embodiment. As illustrated in FIG. 9, the biometric security module 240 comprises a wearing state estimation module 141, an action estimation module 242, a power supply management module 143, and a fingerprint authentication module 245.

The action estimation module 242 estimates action of the user who wears the wearable device 100, based on acceleration measured by the accelerometer 210. Further, the action estimation module 242 estimates the change in action over time based on accelerations measured at different measurement time. Here, “action” is action of the user, and is for example action such as “at rest”, “walking”, “at rest in vehicle”, and “walking in vehicle”. Further, the “change in action over time” indicates change in action of the user over time such as when the action is changed from “at rest” to “walking” over time. Different modes of the “action” and the “change in action over time” are distinguished from each other by raising flags corresponding to the modes.

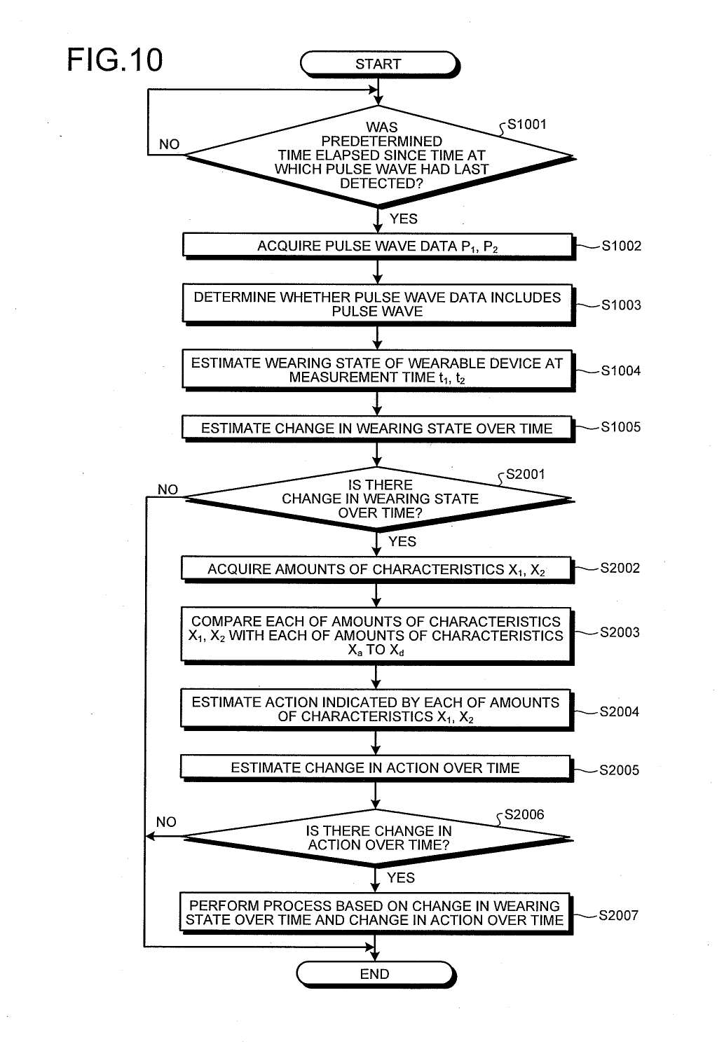

Next, a biometric security process executed by the biometric security module 240 is explained. FIG. 10 is a flowchart of the biometric security process of the second embodiment. Here, S1001 to S1005 are the same as that of the first embodiment, thereby the explanations thereof are omitted.

After S1005, the action estimation module 242 determines whether the wearing state is changed over time (S2001). As a result, if it is determined that the wearing state is not changed over time (No at S2001), the process ends. On the other hand, if it is determined that the wearing state is changed over time (Yes at S2001), the action estimation module 242 acquires the change in acceleration over time measured by the accelerometer 210 with reference to the measurement time t₁ as an amount of characteristic X₁ and the change in acceleration over time measured by the accelerometer 210 with reference to the measurement time t₂ as an amount of characteristic X₂ (S2002). Next, the action estimation module 242 compares the amounts of characteristics X₁, X₂ with each of predetermined amounts of characteristics Xₐ to X_{d} (S2003). Then, the action estimation module 242 estimates the action of the user at each of the measurement times t₁, t₂ based on the comparison result of 52003 (S2004).

Here, the predetermined amounts of characteristics Xₐ to X_{d} are obtained by quantifying the pattern of the change in acceleration over time measured by the accelerometer 210 when the user takes a predetermined action. In general, acceleration indicates different patterns of change over time if actions are different. For example, a pattern of change in acceleration over time at the time of walking differs from a pattern of change in acceleration over time at the time of walking in the vehicle. Therefore, the present embodiment uses such a difference between the patterns of the change in acceleration over time. In particular, according to the present embodiment, a measured amount of characteristic indicating a predetermined pattern of change in acceleration overtime is compared with a preliminarily stored amount of characteristic indicating a predetermined pattern of change in acceleration over time stored in the ROM 102 and the like. Then, it is estimated which user action the measured amount of characteristic indicating the pattern of change in acceleration over time corresponds. Here, in the present embodiment, the predetermined amount of characteristic Xₐ represents a pattern of change in acceleration over time of when the user is “at rest”. Further, the predetermined amount of characteristic X_{b} represents a pattern of change in acceleration over time of when the user is “walking”. Further, the predetermined amount of characteristic X_{c} represents a pattern of change in acceleration over time of when the user is “at rest in vehicle”. Still further, the predetermined amount of characteristic X_{d} represents a pattern of change in acceleration over time of when the user is “waling in vehicle”.

Next, the action estimation module 242 estimates change in action over time based on the action at the measurement time t₁ and the action at the measurement time t₂ (S2005).

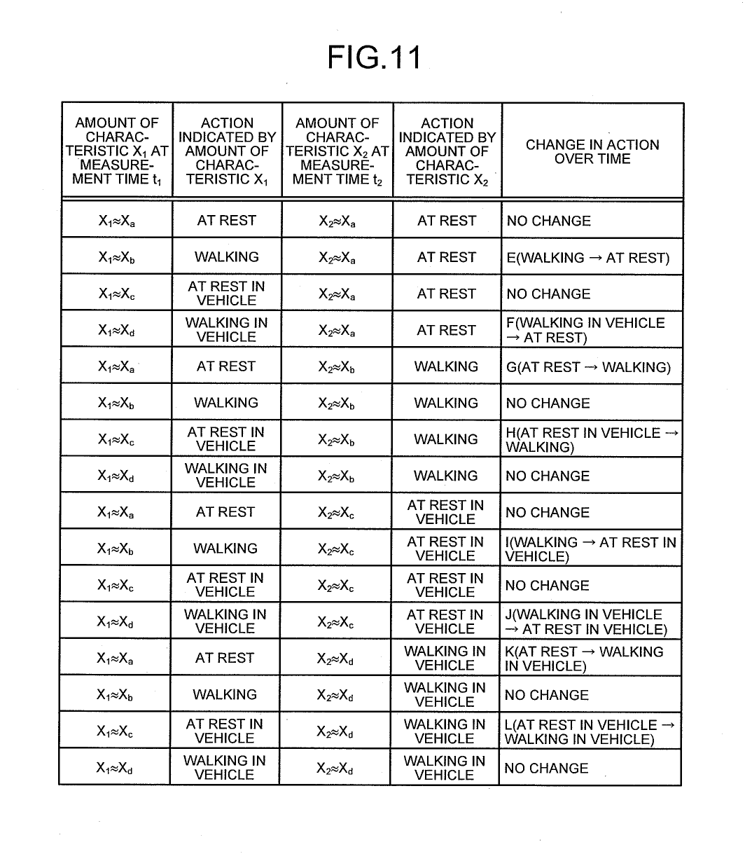

FIG. 11 is a table for explaining actions of the user and the change in action of user over time. As illustrated in FIG. 11, the action estimation module 242 compares the amount of characteristic X₁ at the measurement time t₁ with each of the predetermined amounts of characteristics Xₐ to X_{d}. Then, the action estimation module 242 estimates action indicated by one of the predetermined amounts of characteristics which substantially matches the amounts of characteristic X₁ as action of the user at the measurement time t₁. For example, if it is determined that the amount of characteristic X₁ substantially matches the amount of characteristic Xₐ, the action estimation module 242 estimates that the action indicated by the amount of characteristic X₁ is “at rest”. Further, if it is determined that the amount of characteristic X₁ matches with the amount of characteristic X_{b}, it is determined that the action indicated by the amount of characteristic X₁ is “walking”. Still further, if it is determined that the amount of characteristic X₁ matches with the amount of characteristic X₀, it is determined that the action indicated by the amount of characteristic X₁ is “at rest in vehicle”. Still further, if it is determined that the amount of characteristic X₁ matches with the amount of characteristic X_{d}, it is determined that the action indicated by the amount of characteristic X₁ is “walking in vehicle”.

Then, the action estimation module 242 compares the action indicated by the amount of characteristic X₁ at the measurement time t₁ with the action indicated by the amount of characteristic X₂ at the measurement time t₂. Then, if the action is changed from “walking” to “at rest” over time, the action estimation module 242 estimates that the change in action over time is E (walking→at rest). Further, if the action is changed from “walking in vehicle” to “at rest” over time, the action estimation module 242 estimates that the change in action over time is F (walking in vehicle→at rest). Further, if the action is changed from “at rest” to “walking” over time, the action estimation module 242 estimates that the change in action over time is G (at rest→walking). Further, if the action is changed from “at rest in vehicle” to “walking” over time, the action estimation module 242 estimates that the change in action over time is H (at rest in vehicle→walking). Further, if the action is changed from “walking” to “at rest in vehicle” over time, the action estimation module 242 estimates that the change in action over time is I (walking→at rest in vehicle). Further, if the action is changed from “walking in vehicle” to “at rest in vehicle” over time, the action estimation module 242 estimates that the change in action over time is J (walking in vehicle→at rest in vehicle). Further, if the action is changed from “at rest” to “walking in vehicle” over time, the action estimation module 242 estimates that the change in action over time is K(at rest→walking in vehicle). Further, if the action is changed from “at rest in vehicle” to “walking in vehicle” over time, the action estimation module 242 estimates that the change in action over time is L(at rest in vehicle→walking in vehicle).

Referring back to FIG. 10, after S2005, the fingerprint authentication module 245 determines whether the action is changed over time (S2006). As a result, if it is determined that the action is not changed over time (No at S2006), the process ends. On the other hand, if it is determined that the action is changed over time (Yes at S2006), the fingerprint authentication module 245 executes a process corresponding to both the change in wearing state over time estimated at S1004 and the change in action over time estimated at S2005 (S2007), and ends the process.

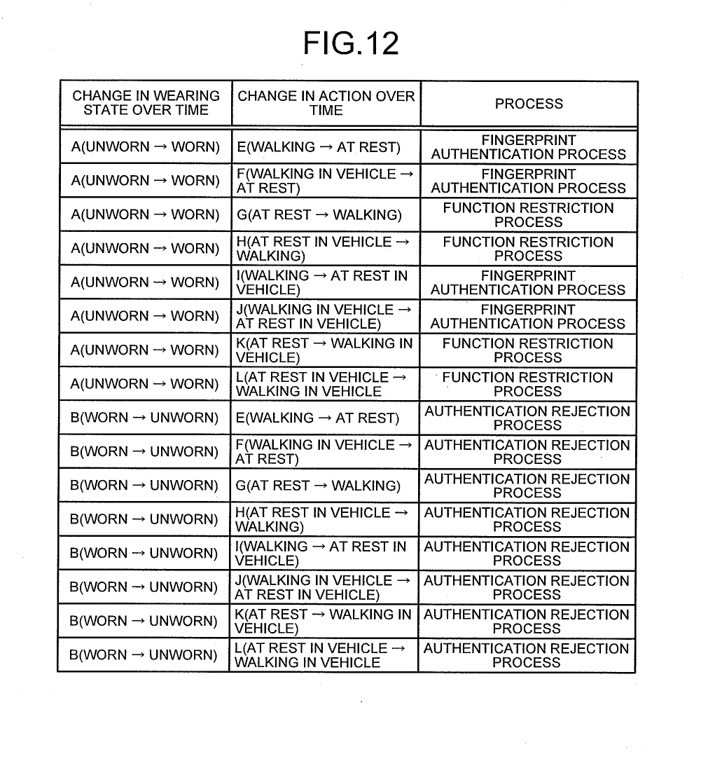

FIG. 12 is a table for explaining a process performed according to the change in wearing state of the wearable device 200 over time and the change in action of the user over time. As illustrated in FIG. 12, if the wearing state of the wearable device 2200 is A (unworn→worn) and the change in action over time is E (walking→at rest), the fingerprint authentication module 245 performs the fingerprint authentication process illustrated in FIG. 7. Similarly, if the wearing state is A (unworn→worn) and the change in action over time is one of F (walking in vehicle→at rest), I (walking→at rest in vehicle), and J (walking in vehicle→at rest in vehicle), the fingerprint authentication process illustrated in FIG. 7 is performed.

Further, if the change in the wearing state over time is A (unworn→worn) and the change in action over time is one of G (at rest→walking), H (at rest in vehicle→walking), K (at rest→walking in vehicle), and L (at rest in vehicle→walking in vehicle), the fingerprint authentication module 245 performs function restriction process.

Here, the function restriction process is a process that enables the user to perform only limited functions of the wearable device 200 without going through the fingerprint authentication process illustrated in FIG. 7. In particular, when the function restriction process is performed, the user becomes capable of using limited functions of the wearable device 200 without going through the fingerprint authentication process, while the user is restricted so as not to be able to view the past physiological information or activity histories or to operate the smartphone. Here, the limited functions of the wearable device 200 are, for example, a function to start measuring the physiological information, etc.

Further, if it is estimated that the change in wearing state over time is B (worn→unworn), the fingerprint authentication module 245 performs the authentication rejection process that is similar to that of the first embodiment, independently of the change in action over time.

As described above, the wearable device 200 of the present embodiment includes the fingerprint sensor 105. Further, the wearable device 200 of the present embodiment performs controlling to turn on and off the power of the fingerprint sensor 105 in accordance with different modes of the changes in the wearing state of the wearable device 200 over time, and performs the fingerprint authentication process. Consequently, the security can be enhanced as well as the power consumption of the wearable device 100 can be reduced since the power of the fingerprint sensor can be turned on only when required.

Further, the wearable device 200 of the present embodiment determines whether to turn on and off the power of the fingerprint sensor based on the change in action over time in addition to the change in wearing state over time. Therefore, it becomes possible to turn on and off the power of the fingerprint sensor more in details.

The present embodiment is described for the case when four types of action, i.e., “at rest”, “walking”, “at rest in vehicle”, and “walking in vehicle” are estimated. However, the present embodiment is not limited thereto, and the types of actions may include other actions such as, for example, “running” and “swimming”. In such case, the fingerprint authentication module may be configured to perform different process in accordance with such user actions. In particular, if for example the user action changes over time from “at rest” to “running”, the fingerprint authentication module may be configured to perform a process different from the process of when the user action is changed from “at rest” to “walking”. Here, the wearable device of the present embodiment can be configured to adopt other user action by firmware update of the wearable device and the like.

Further, if the function restriction process is performed, the wearable device of the present embodiment may notify it to the user in user recognizable mode (e.g., displaying on the touch panel display or outputting from a speaker or vibrator not illustrated).

### Modification

In the second embodiment, it is explained that the function restriction process is performed when the wearing state is A (unworn→worn) and the change in action over time is one of G (at rest→walking), H (at rest in vehicle→walking), K (at rest→walking in vehicle), and L (at rest in vehicle→walking in vehicle). However, the present embodiment is not limited thereto, and for example, the fingerprint authentication process illustrated in FIG. 7 may be performed while degrading the authentication accuracy.

In particular, for example, if the user start walking while the wearable device is unworn, and subsequently, the user wears the wearable device while walking, the matching accuracy between the registered fingerprint data and the acquired fingerprint data is lowered compared to that of the usual case. Consequently, even if the fingerprint reading is insufficiently performed due to the user's walking motion, the user authentication can be performed.

### Third Embodiment

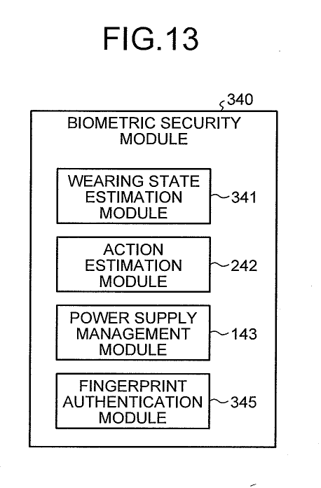

Next, a third embodiment is explained based on FIGS. 13 to 16. FIG. 13 is a block diagram of a biometric security module 340 of the present embodiment. The biometric security module 340 of the present embodiment comprises a wearing state estimation module 341, an action estimation module 242, a power supply management module 143, and a fingerprint authentication module 345. In the following, the same components as that of the first and second embodiments are referred to by the same numerals, and the explanations thereof are omitted.

According to the second embodiment, the wearing state estimation module 141 cannot distinguish between the case when the wearing state does not change over time while the wearable device is unworn and the case when the wearing state does not change over time while the wearable device is worn. Therefore, when the user starts walking at the same time when the wearable device 200 is worn and thereby the function restriction process is executed, and subsequently the user stops walking while wearing the wearable device 200, the fingerprint authentication process is not going to be performed automatically. However, motion of the user's fingertip is stable by the time when the user stops, and therefore the fingerprint authentication process can be performed. Therefore, according to the present embodiment, the state in which the wearing state does not change over time is distinguished between the case when the wearable device is worn and the case when the wearable device is unworn. Then, a re-authentication process is performed automatically in accordance with the change in the distinguished wearing state over time.

As similar to the wearing state estimation module 141 of the first embodiment, the wearing state estimation module 341 estimates the wearing state of the wearable device 100 based on the pulse waves measured by the pulse wave sensor 106. Further, as similar to the wearing state estimation module 141 of the first embodiment, the wearing state estimation module 341 estimates the change in the wearing state over time based on the pulse waves measured at different measurement times. Here, the wearing state estimation module 341 of the present embodiment differs from the wearing state estimation module 141 of the first embodiment in that the wearing state estimation module 341 distinguishes the state in which there is no change in the wearing state over time between when the wearable device is worn and when the wearable device is unworn.

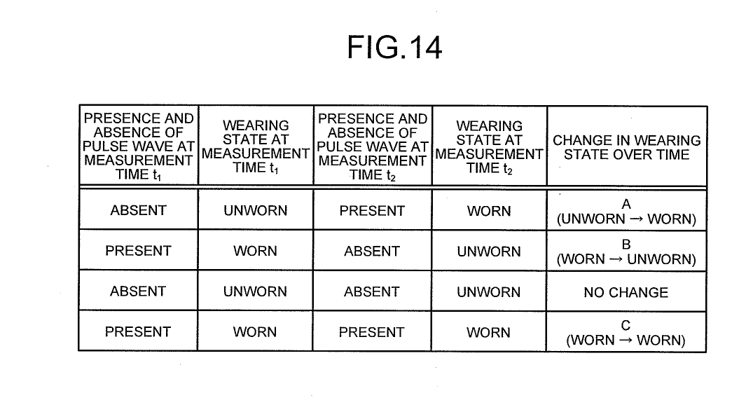

FIG. 14 is a table for explaining the wearing state and the change in the wearing state over time estimated by the wearing state estimation module 341 of the present embodiment. As illustrated in FIG. 14, if both the wearing state at the measurement time t₁ and the wearing state at the measurement time t₂ are “unworn”, the wearing state estimation module 341 estimates that there is no change in the wearing state over time. On the other hand, if both the wearing state at the measurement time t₁ and the wearing state at the measurement time t₂ are “worn”, the wearing state estimation module 341 estimates that the change in the wearing state over time is C (worn→worn). Consequently the state in which there is no change in the wearing state over time can be distinguished between the case when the wearable device is worn and the case when the wearable device is unworn.

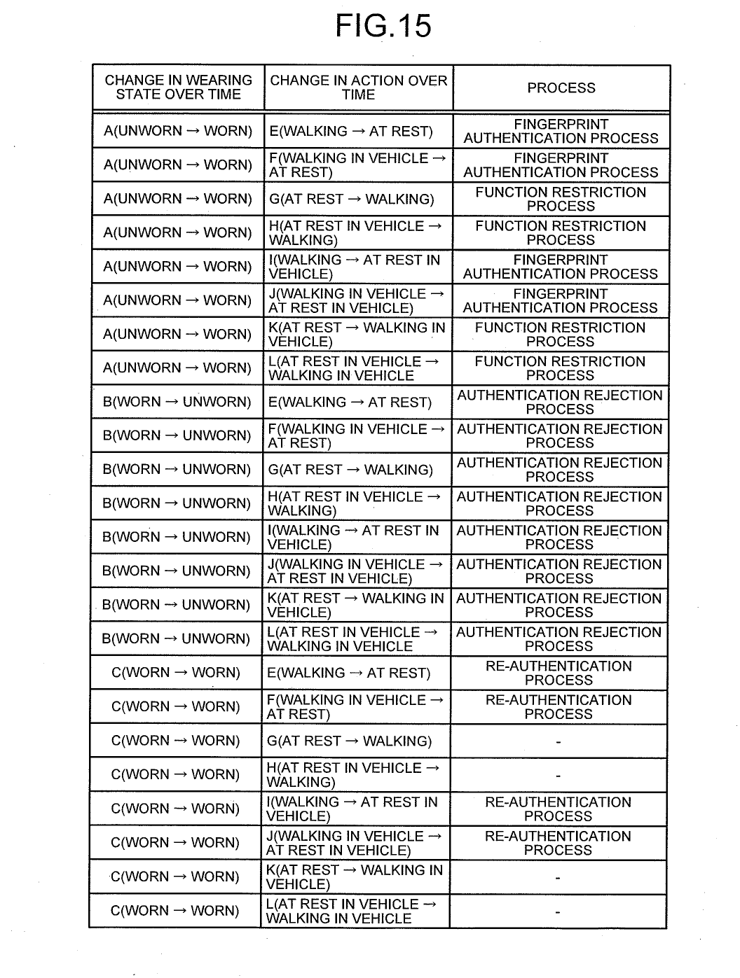

As similar to the fingerprint authentication module 245 of the second embodiment, the fingerprint authentication module 345 of the present embodiment determines whether to turn on and off the power of the fingerprint sensor based on the change in wearing state over time and the change in action over time. Here, as different from the fingerprint authentication module 245 of the second embodiment, if the wearing state does not change over time while in the worn state, the fingerprint authentication module 345 of the present embodiment performs the re-authentication process described later. Further, as different from the fingerprint authentication module 245 of the second embodiment, when the function restriction process is performed, the fingerprint authentication module 245 of the present embodiment records that such a process is performed in, for example, the ROM 102 by raising a flag, etc. FIG. 15 is a table for explaining various processes executed by the fingerprint authentication module 345 in accordance with the change in wearing state over time and the change in action over time. As illustrated in FIG. 15, if the change in wearing state over time is C(worn→worn) and the change in action over time is one of E (walking→at rest), F (walking in vehicle→at rest), I (walking→at rest in vehicle), and J(walking in vehicle→at rest in vehicle), the fingerprint authentication module 345 performs the re-authentication process.

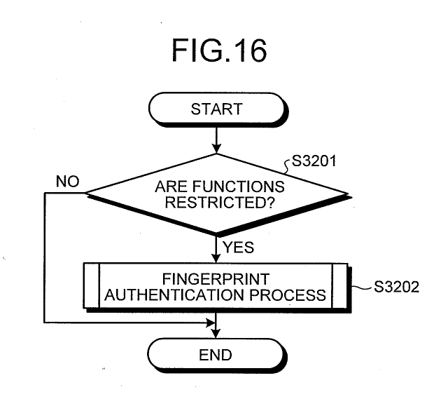

FIG. 16 is a flowchart of the re-authentication process performed by the fingerprint authentication module 345. As illustrated in FIG. 16, when the re-authentication process is started, the fingerprint authentication module 345 determines whether the functions of the wearable device 100 are restricted (S3201). Here, the determination on whether the functions are restricted is determined by referring to the flag and the like recorded in the ROM 102, for example.

As a result, if it is determined that the functions are restricted (Yes at S3201), the fingerprint authentication process illustrated in FIG. 7 is performed (S3202), and the process ends. On the other hand, if it is determined that the functions are not restricted (No at S3201), the process ends.

As described above, the wearable device of the present embodiment includes the fingerprint sensor. Further, the wearable device of the present embodiment performs controlling to turn on and off the power of the fingerprint sensor in accordance with different modes of the changes in the wearing state of the wearable device over time, and performs the fingerprint authentication process. Consequently, the security can be enhanced as well as the power consumption of the wearable device 100 can be reduced since the power of the fingerprint sensor can be turned on only when required.

Further, the wearable device of the present embodiment determines whether to turn on and off the power of the fingerprint sensor based on the change in action over time in addition to the change in wearing state over time. Therefore, it becomes possible to turn on and off the power of the fingerprint sensor more in details.

Further, the wearable device of the present embodiment distinguishes between the state in which the wearing state does not change over time while the wearable device is unworn and the state in which the wearing state does not change over time while the wearable device is worn. Then, the re-authentication process is performed in accordance with the distinguished change in wearing state over time. Consequently, the re-authentication process of the user authentication can automatically be performed for the case when the user starts walking at the same time the user wears the wearable device and thereby the function restriction process is performed, and thereafter, the user stops while wearing the wearable device.

### Fourth Embodiment

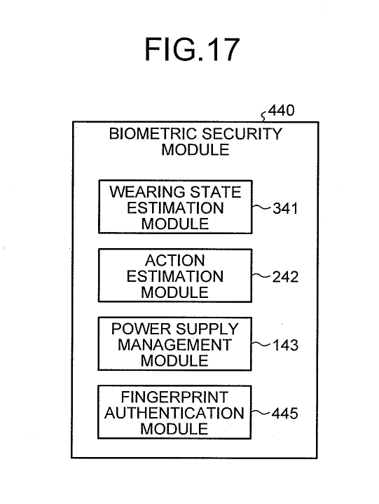

Next, a fourth embodiment is explained based on FIGS. 17 to 19. FIG. 17 is a block diagram of a biometric security module 440 of the fourth embodiment. The biometric security module 440 of the present embodiment comprises the wearing state estimation module 341, the action estimation module 242, the power source management module 143, and a fingerprint authentication module 445. In the following, the components similar to that of the first to the third embodiments are referred to by the same numerals, and the explanations thereof are omitted.

According to the fingerprint authentication module 345 of the third embodiment, when the user authentication is once approved, the approved state is maintained until the wearable state is unworn. Therefore, if the user drops the wearable device while walking and a third person picks up the wearable device and tries to use it, the third person might be able to use the wearable device without going through the user authentication. In particular, it is considered a case when a third person picks up the wearable device and wears it before the change in the wearing state over time of (worn→unworn) is detected (e.g., 30 seconds). In this case, the wearing state is changed from the state in which the user is wearing the wearable state to the state in which the third person is wearing the wearable device, therefore the worn state is maintained. Thus, the user authentication is maintained to be approved, and thereby the third person who picks up the wearable device is able to use the wearable device. Therefore, according to the present embodiment, if the user's action is changed over time from at rest to walking while wearing the wearable device, the user authentication is rejected and the functions are restricted while walking.

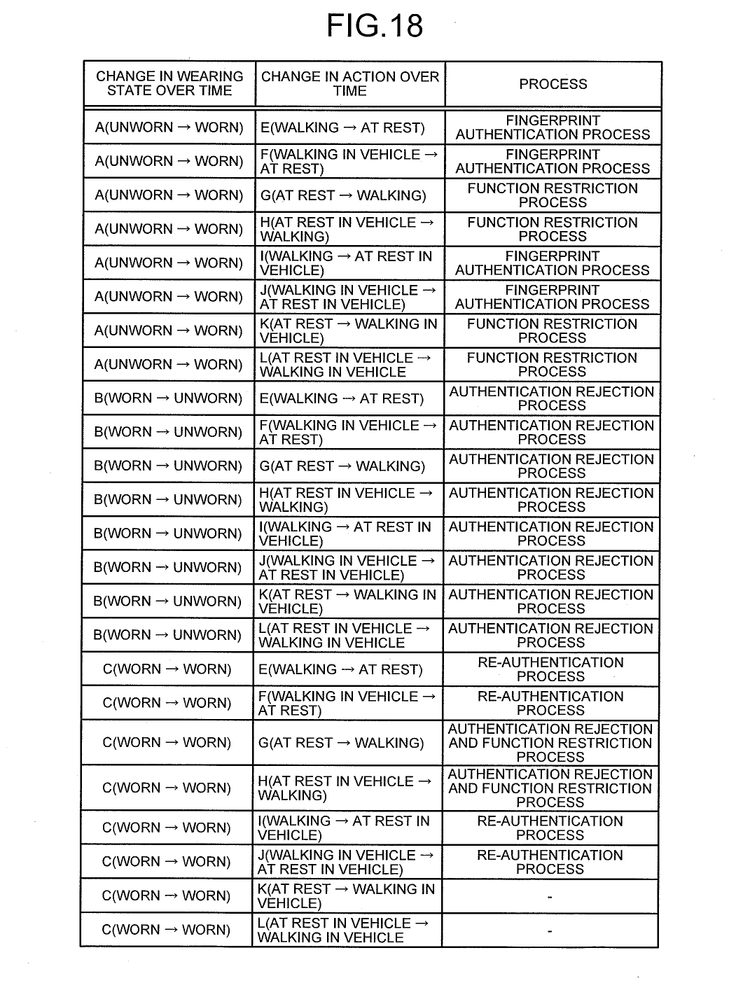

As similar to the fingerprint authentication module 245 of the third embodiment, the fingerprint authentication module 445 determines whether to turn on and off the power of the fingerprint sensor based on the change in wearing state over time and the change in action over time. Here, as different from the fingerprint authentication module 345 of the third embodiment, if the change in action over time is changed from “at rest” or “at rest in vehicle” to “walking” while the wearing state is being worn, the fingerprint authentication module 445 of the present embodiment performs an authentication rejection and function restriction process described later. FIG. 18 is a table for explain various processes executed by the fingerprint authentication module 445 in accordance with the change in wearing state over time and the change in action over time. As illustrated in FIG. 18, if the change in wearing state over time is C (worn→worn) and the change in action over time is G (at rest→walking) or H (at rest in vehicle→walking), the fingerprint authentication module 445 performs the authentication rejection and function restriction process.

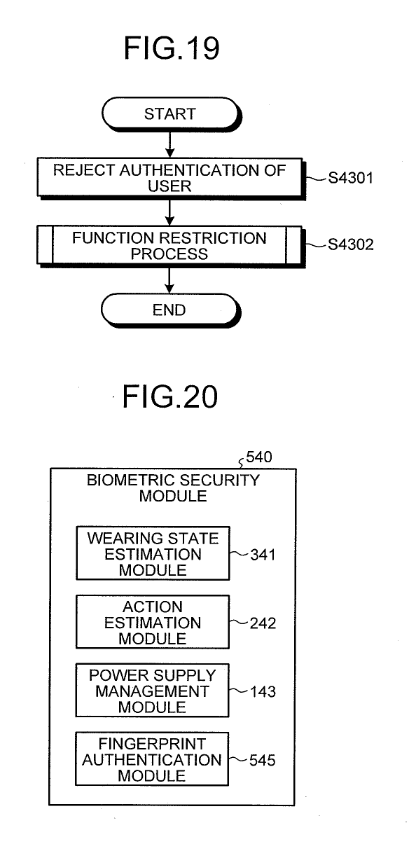

FIG. 19 is a flowchart of the authentication rejection and function restriction process. As illustrated in FIG. 19, when the authentication rejection and function restriction process is started, the fingerprint authentication module 445 rejects the user authentication that had been approved by the fingerprint authentication process in the past (S4301). Thereafter, the fingerprint authentication module 445 performs the function restriction process of the third embodiment (S4302).

As described above, the wearable device of the present embodiment includes the fingerprint sensor. Further, the wearable device of the present embodiment performs controlling to turn on and off the power of the fingerprint sensor in accordance with different modes of the changes in the wearing state of the wearable device over time, and performs the fingerprint authentication process. Consequently, the security can be enhanced as well as the power consumption of the wearable device 100 can be reduced since the power of the fingerprint sensor can be turned on only when required.

Further, the wearable device of the present embodiment determines whether to turn on and off the power of the fingerprint sensor based on the change in action over time in addition to the change in wearing state over time. Therefore, it becomes possible to turn on and off the power of the fingerprint sensor more in details.

Further, the wearable device of the present embodiment distinguishes between the state in which the wearing state does not change over time while the wearable device is unworn and the state in which the wearing state does not change over time while the wearable device is worn. Then, the re-authentication process is performed in accordance with the distinguished change in wearing state over time. Consequently, the re-authentication process of the user authentication can automatically be performed for the case when the user starts walking at the same time the user wears the wearable device and thereby the function restriction process is performed, and thereafter, the user stops while wearing the wearable device.

Further, the wearable device of the present embodiment rejects the user authentication when the action of the user is changed from at rest to in motion while the wearable device is being worn, and restricts the functions while in motion. Consequently, even in a case when the user drops the wearable device for example, the security can surely be enhanced.

### Fifth Embodiment

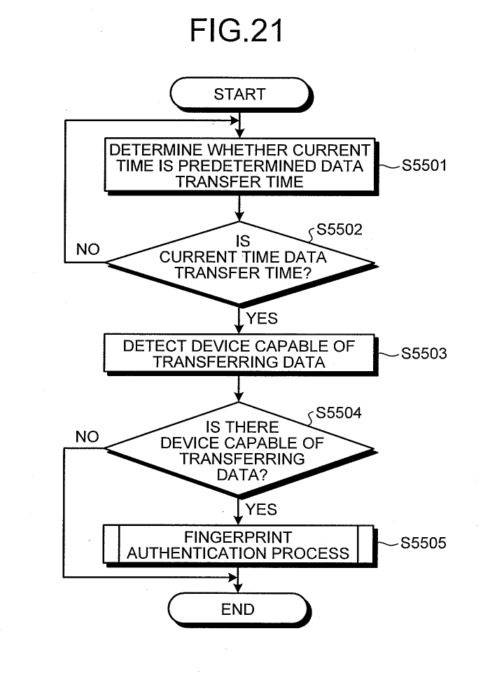

Next, a fifth embodiment is explained based on FIGS. 20 and 21. FIG. 20 is a block diagram of a biometric security module 540 of the present embodiment. The biometric security module 540 comprises the wearing state estimation module 341, the action estimation module 242, the power source management module 143, and a fingerprint authentication module 545. In the following, the components similar to that of the first to fourth embodiments are referred to by the same numerals, and the explanations thereof are omitted.

According to the fingerprint authentication module of the first to the fourth embodiments, security for when data such as the activity histories is transmitted from the wearable device to the smartphone and the like is not considered. Therefore, according to the present embodiment, the fingerprint authentication process is performed at the time of data transfer.

As similar to the fingerprint authentication module 445 of the fourth embodiment, the fingerprint authentication module 545 determines whether to turn on and off the power of the fingerprint sensor based on the change in the wearing state over time and the change in action over time. However, as different from the fingerprint authentication module 445 of the fourth embodiment, the fingerprint authentication module 545 of the present embodiment performs the fingerprint authentication when data such as the physiological information or the activity histories are uploaded from the wearable device to an external device.

FIG. 21 is a flowchart of the fingerprint authentication process performed by the fingerprint authentication module 545 of the present embodiment at the time of the data transfer. As illustrated in FIG. 21, the fingerprint authentication module 545 determines whether the current time is a predetermined data transfer time (S5501). Here, the predetermined data transfer time is a time set every day by the user, such as 21 o'clock.

Next, if it is determined that the current time is not the predetermined data transfer time (No at S5502), the fingerprint authentication module 545 repeats the process of S5501. On the other hand, if it is determined that the current time is the predetermined data transfer time (Yes at S5502), the fingerprint authentication module 545 detects a device capable of data transfer (S5503).

Thereafter, the fingerprint authentication module 545 determines whether there are any devices capable of data transfer near by, based on the detection result at S5503 (S5504). As a result, if it is determined that there is not device capable of data transfer near by (No at S5504), the fingerprint authentication module 545 ends the process. On the other hand, if it is determined that there is a device capable of data transfer near by, the fingerprint authentication module 545 performs the fingerprint authentication process illustrated in FIG. 7 (S5505), and ends the process.

As described above, the wearable device of the present embodiment includes the fingerprint sensor. Further, the wearable device of the present embodiment performs controlling to turn on and off the power of the fingerprint sensor in accordance with different modes of the changes in the wearing state of the wearable device over time, and performs the fingerprint authentication process. Consequently, the security can be enhanced as well as the power consumption of the wearable device 100 can be reduced since the power of the fingerprint sensor can be turned on only when required.

Further, the wearable device of the present embodiment determines whether to turn on and off the power of the fingerprint sensor based on the change in action over time in addition to the change in wearing state over time. Therefore, it becomes possible to turn on and off the power of the fingerprint sensor more in details.

Further, the wearable device of the present embodiment distinguishes between the state in which the wearing state does not change over time while the wearable device is unworn and the state in which the wearing state does not change over time while the wearable device is worn. Then, the re-authentication process is performed in accordance with the distinguished change in wearing state over time. Consequently, the re-authentication process of the user authentication can automatically be performed for the case when the user starts walking at the same time the user wears the wearable device and thereby the function restriction process is performed, and thereafter, the user stops while wearing the wearable device.

Further, the wearable device of the present embodiment rejects the user authentication when the action of the user is changed from at rest to in motion while the wearable device is being worn, and restricts the functions while in motion. Consequently, even in a case when the user drops the wearable device for example, the security can surely be enhanced.

Further, the wearable device of the present embodiment performs fingerprint authentication process when data such as the activity histories of the user is transmitted from the wearable device to other devices. Consequently, the security of the wearable device can further be enhanced.

In the present embodiment, there is explained an example in which a device to which data can be transferred is detected when the current time becomes the predetermined data transfer time. However, the present embodiment is not limited thereto, and a device to which data can be transferred can be detected in response to an operation of the user with respect to the wearable device. Further, a device to which data can be transferred can be detected when the wearable device is positioned at a predetermined location. In other word, the fingerprint authentication process of the present embodiment can be performed at any timing when the data is to be transferred.

In the first to the fifth embodiments, it is explained an example in which the electronic device is applied to a watch type wearable device that is worn around a wrist of the user. However, the electronic device can be applied to a wearable device other than the watch type wearable device, such as a smart glass. Further, the electronic device can be applied not only to the wearable device but any device with comparatively large power consumption with respect to its battery capacity.

According to the first to the fifth embodiments, the wearing state of the wearable device is estimated by using the pulse wave sensor. However, the embodiments are not limited thereto, and any sensor can be used as long as the sensor can detect whether the wearable device is worn by a user, such as a temperature sensor. Further, it is possible to detect the wearing state of the wearable device can be estimated by using a combination of a plurality of sensors.

According to the first to the fifth embodiments, the user authentication is performed by using the fingerprints. However, the embodiments are not limited thereto, and any authentication method such as iris recognition, face recognition, authentication by using shape of palm, voice recognition, signature recognition, retina recognition, vein authentication, can be used. If such an authentication method is to be used, a sensor that can measure the target to be recognized for the authentication should be provided.

Further, according to the first to the fifth embodiments, action of the user is estimated by using an accelerometer. However, embodiments are not limited thereto, and any sensor can be used as long as the sensor can detect what action the user is taking. Further, the action of the user can be estimated by using a combination of a plurality of sensors.

Further, the wearable device of the first to the fifth embodiments can notify the user that the authentication process is started in a user recognizable manner (i.e., displaying on the touch panel display 104 or outputting via a speaker or a vibrator not illustrated).

Further, according to the first to the fifth embodiments, it is explained an example in which the program executed by the wearable device is preliminarily stored in the ROM provided in the wearable device and provided as a computer program product. However, the program can be configured so as to be provided or distributed as a computer program product via a computer connected to the wearable device in wireless or wired manner.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device wearable by a user, comprising:
a first sensor to measure first physiological information of the user, the first physiological information used to determine a wearing state of the electronic device;
a second sensor to measure second physiological information of the user;
processing circuitry to perform authentication of a user by using the second physiological information; and
a power supply circuitry to start, when a wearing state of the electronic device changes from an unworn state to a worn state, supplying power to the second sensor, and to stop, when the authentication of the user is completed, at least a portion of supplying power to the second sensor.

2. The electronic device of claim 1, wherein,
the processing circuitry comprises:
to approve a user after an authentication of a user is completed and while the electronic device is in a worn state, and
to reject the user when a wearing state of the electronic device is changed from the worn state to the unworn state.

3. The electronic device of claim 1, wherein
the first physiological information comprises at least information related to motion of the user wearing the electronic device, and,
when the user is determined to be in a moving state based on the information related to the motion of the user, the processing circuitry comprises to enable the authentication of the user while degrading accuracy of the authentication of the user, or to make the electronic device usable without performing the authentication while restricting functions of the electronic device to at least some of the functions.

4. The electronic device of claim 1, wherein
the first physiological information comprises at least information related to motion of the user wearing the electronic device,
when the user is determined to be in a moving state based on the information related to the motion of the user, the processing circuitry comprises to reject the user, and,
when the user is determined not to be in the moving state based on the information related to the motion of the user, the processing circuitry comprises to enable the authentication of the user.

5. The electronic device of claim 1, wherein, upon transferring data from the electronic device to outside, the processing circuitry comprises to enable the authentication of the user.

6. A method executed by an electronic device wearable by a user, the method comprising:
detecting first physiological information of the user by using a first sensor to measure the first physiological information used to determine a wearing state of the electronic device;
detecting second physiological information of the user by using a second sensor to measure the second physiological information;
performing authentication of a user by using the second physiological information; and,
supplying, when the wearing state of the electronic device is changed from an unworn state to a worn state, power to the second sensor, and stopping, when the authentication of the user is completed, at least a portion of supplying power to the second sensor.

7. The method of claim 6, further comprising:
maintaining, after an authentication of a user is completed and while the electronic device is in a worn state, the user approved; and
rejecting, when a wearing state of the electronic device is changed from the worn state to the unworn state, the user.

8. The method of claim 6, wherein
the first physiological information comprises at least information related to motion of the user wearing the electronic device, and
the method further comprises: enabling, when the user is determined to be in a moving state based on the information related to the motion of the user, the authentication of the user while degrading accuracy of the authentication of the user, or making the electronic device usable without performing the authentication while restricting functions of the electronic device to at least some of the functions.

9. The method of claim 6, wherein
the first physiological information comprises at least information related to motion of the user wearing the electronic device, and
the method further comprises:
rejecting, when the user is determined to be in a moving state based on the information related to the motion of the user, the authentication of the use, and
enabling, when the user is determined not to be in the moving state based on the information related to the motion of the user, the authentication of the user.

10. The method of claim 6, further comprising enabling, upon transferring data from the electronic device to outside, the authentication of the user.

11. A computer program product having a non-transitory computer readable medium including programmed instructions for an electronic device, the electronic device being wearable by a user, wherein the instructions, when executed by a computer, cause the computer to perform:
detecting first physiological information of the user by using a first sensor to measure the first physiological information used to determine a wearing state of the electronic device;
detecting second physiological information of the user by using a second sensor to measure the second physiological information;
performing authentication of a user by using the second physiological information; and,
supplying, when a wearing state of the electronic device is changed from an unworn state to a worn state, power to the second sensor, and stopping, when the authentication of the user is completed, at least a portion of supplying power to the second sensor.

12. The computer program product of claim 11, further comprising:
maintaining, after an authentication of a user is completed and while the electronic device is in a worn state, the user approved; and
rejecting, when a wearing state of the electronic device is changed from the worn state to the unworn state, the user.

13. The computer program product of claim 11, wherein
the first physiological information comprises at least information related to motion of the user wearing the electronic device, and
the computer program product further causes the computer to perform enabling, when the user is determined to be in a moving state based on the information related to the motion of the user, the authentication of the user while degrading accuracy of the authentication of the user, or making the electronic device usable without performing the authentication while restricting functions of the electronic device to at least some of the functions.

14. The computer program product of claim 11, wherein
the first physiological information comprises at least information related to motion of the user wearing the electronic device, and
the computer program product further causes the computer to perform:
rejecting, when the user is determined to be in a moving state based on the information related to the motion of the user, the authentication of the use, and
enabling, when the user is determined not to be in the moving state based on the information related to the motion of the user, the authentication of the user.

15. The computer program product of claim 11, further causes the computer to perform enabling, upon transferring data from the electronic device to outside, the authentication of the user.
